(19) United States
(12) Patent Application Publication
(10) Pub. No.: US 2005/0089041 A1
(43) Pub. Date: Apr. 28, 2005

(54) Method and apparatus for assisting a mobile node to transmit a packet

(75) Inventors: Ajaykumar P. Idnani, Schaumburg, IL (US); Timothy J. Wilson, Rolling Meadows, IL (US)

Correspondence Address: POSZ & BETHARDS, PLC, 11250 ROGER BACON DRIVE, SUITE 10, RESTON, VA, 20190, US

(73) Assignee: MOTOROLA, INC.

(21) Appl. No.: 10/695,608

(22) Filed: Oct. 28, 2003

(51) Int. Cl. H04L 12/56

(52) U.S. Cl. 370/395.5; 370/328

(57) ABSTRACT

A mobility-unaware mobile node (MN) (112) in a visited subnet (110) different from its home subnet (108) sends (302) an ARP Request to discover a first MAC address of a device in the home subnet, the ARP Request containing an IP address assigned to the device. A software program, designated host (106) in the visited subnet and corresponding method of assisting the MN (112) receives (304) the ARP Request, and determines that the IP address does not belong to the visited subnet. In response, the designated host returns (310) an ARP Response containing its own MAC address, which the mobile node will assume to be the MAC address of the device in the home subnet and use for sending packets to the device.

### FIELD OF THE INVENTION

This invention relates in general to communication systems, and more specifically to a method and apparatus for assisting a mobile node to transmit a packet in a foreign network.

### BACKGROUND OF THE INVENTION

In a mobile environment, it is possible that a mobile node (MN) does not have a mobile IP stack or other mobility software and hence is mobility unaware. Such a MN does not know when it changes subnets. When a MN leaves its home subnet, the Fixed Network Equipment (FNE) needs to tunnel all packets from the MN's home subnet to the MN's visited subnet. It also needs to reverse tunnel the packets from the MN's visited subnet to the home subnet.

However, when a mobility-unaware MN is in a visited subnet and wants to send a packet, it will send out an Address Resolution Protocol (ARP) Request to discover the Medium Access Control (MAC) address of another host or local router in its home subnet, as if it were in its home subnet. Since there will be no nodes in the visited s-ubnet with the IP address indicated in the ARP Request, no node will respond to the request, and hence the MN will not be able to send the packet.

Thus, what is needed is a method and apparatus for assisting a MN to send a packet from a visited subnet.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages in accordance with the present invention.

FIG. 1 is an exemplary electrical block diagram depicting a plurality of subnets in a corporate intranet.

FIG. 2 is an exemplary electrical block diagram of a host.

FIG. 3 is a flow diagram depicting interactions between the host and a mobile node.

### DETAILED DESCRIPTION OF THE PREFERRED EMBODIMENTS

In overview, the present disclosure concerns communications systems that utilize transceivers to provide service for communications units or more specifically for users thereof operating therein. More particularly, various inventive concepts and principles embodied as a method and apparatus for assisting a mobile node to transmit a packet for use in equipment with such communications systems will be discussed and disclosed. The communications systems of particular interest are those being deployed and developed such as [CDMA (Code Division Multiple Access), W-CDMA (Wideband-CDMA), CDMA2000, 2.5G (Generation), 3G, UMTS (Universal Mobile Telecommunications Services), OFDM (orthogonal frequency division multiplexing), wireless local area network systems, and evolutions thereof, although the concepts and principles have application in other systems and devices, such as wireline networks.

The instant disclosure is provided to further explain in an enabling fashion the best modes of making and using various embodiments in accordance with the present invention. The disclosure is further offered to enhance an understanding and appreciation for the inventive principles and advantages thereof, rather than to limit in any manner the invention. The invention is defined solely by the appended claims including any amendments made during the pendency of this application and all equivalents of those claims as issued.

It is further understood that the use of relational terms, if any, such as first and second, top and bottom, and the like are used solely to distinguish one from another entity or action without necessarily requiring or implying any actual such relationship or order between such entities or actions.

Much of the inventive functionality and many of the inventive principles are best implemented with or in one or more software programs, conventional processors, or with integrated circuits (ICs) such as custom or application specific ICs. It is expected that one of ordinary skill, notwithstanding possibly significant effort and many design choices motivated by, for example, available time, current technology, and economic considerations, when guided by the concepts and principles disclosed herein will be readily capable of generating such software programs, programming such processors, or generating such ICs with minimal experimentation. Therefore, in the interest of brevity and minimization of any risk of obscuring the principles and concepts according to the present invention, further discussion of such programs, processors and ICs, if any, will be limited to the essentials with respect to the principles and concepts employed by the preferred embodiments.

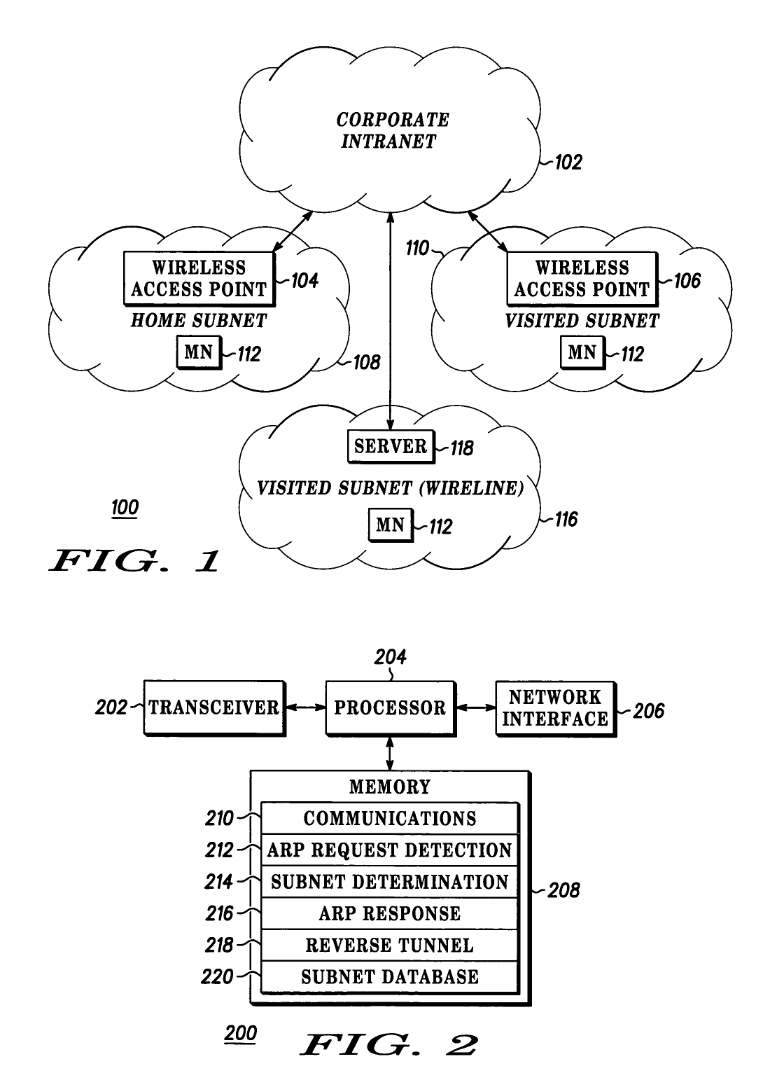

Referring to FIG. 1, an exemplary electrical block diagram 100 depicts a plurality of subnets 108, 110, 116 on a corporate intranet 102. Each of these subnets are organized and operates to provide services and connections among a multitude of network entities or devices including mobile nodes. The subnet 108 is the home subnet to which a mobile node (MN) 112 is assigned. In this example, the MN 112 communicates wirelessly via a protocol consistent with the above noted systems or a WLAN protocol such as IEEE 802.11 protocols, but does not have a mobility stack and is thus mobility unaware or oblivious. The home subnet 108 comprises a wireless access point 104 coupled to the corporate intranet 102 and through which the MN 112 can access the home subnet 108, as well as other devices on the corporate intranet 102.

The MN 112 can leave its home subnet 108 and go, for example, to a visited subnet 110, where the MN 112 can attempt to communicate. Because the MN 112 is mobility unaware, the MN 112 “thinks” it is in the home subnet 108 and, when the MN 112 wants to send a packet, will send according to known techniques an ARP Request containing the IP address of a device, e.g., a router or host, (not shown) in the home subnet 108 to discover the MAC address of the device, as disclosed herein above in the Background of the Invention. In the prior art, this would not work, because no node of the visited subnet 110 would match the IP address contained in the ARP Request. However, in the visited subnet 110, in accordance with an embodiment of the present invention, the wireless access point 106 is or is a portion of a “designated host” for a visiting MN that is mobility unaware, such as the MN 112.

In a first embodiment, when the designated host, i.e., the wireless access point 106, receives and detects an ARP Request containing an IP address that does not belong to the same subnet 110 as that of the wireless access point 106, the wireless access point 106 responds to the ARP Request with the wireless access point's own MAC address. The MN 112 will then address the packet to the wireless access point's MAC address, assuming (incorrectly) that the packet is addressed to the MAC address of the device in the home subnet. When the wireless access point 106 receives the packet, the wireless access point 106 reverse tunnels the packet to the home subnet 108 through a well-known tunneling technique, such as an IP-in-IP encapsulation. The host or router in the home subnet will then process the packet and respond; the response will again be tunneled to the MN 112 via the wireless access point 106.

It will be appreciated that, in a second embodiment, instead of responding to the ARP Request with its own MAC address, the designated host can respond with a “dummy” MAC address that is not used elsewhere in the subnet 110. The designated host would then have to be able to recognize and reverse tunnel any messages sent to the dummy MAC address.

A third embodiment is depicted in a visited subnet 116, which is a wireline network. In this embodiment, the MN 112 is connected to the subnet through a wired connection, and the server 118 is the designated host. When the server 118 detects an ARP Request containing an IP address that does not belong to the same subnet 116 as that of the server 118, the server 118 responds to the ARP Request with the server's own MAC address. The server 118, alternatively, can respond with a dummy MAC address not used in the subnet 116. Then when the server 118 receives a packet from the MN 112, the server 118 reverse tunnels the packet to the home subnet 108.

Referring to FIG. 2, an exemplary electrical block diagram of a host 200 comprises a transceiver 202 coupled to a processor 204 that is further coupled to a network interface 206. In one embodiment, the host 200 is a wireless access point. In this embodiment the transceiver 202 is a conventional wireless transceiver, such as a WiFi transceiver readily available from various suppliers, such as Motorola, Inc. and others. The network interface 206 is a conventional communication port, such as an Ethernet port. The processor is a conventional processor, such as a member of the MC68000 family of processors available from Motorola, Inc.

In another embodiment, the host 200 is a server in a wireline network. In this embodiment, the transceiver 202 and the network interface 206 are both conventional communication ports, such as Ethernet ports, which can be combined into a single port, if desired.

In either embodiment, the host 200 comprises a conventional memory 208 coupled to the processor 204 and containing executable software programs for programming the processor 204 in accordance with the present invention. The memory 208 comprises a communications program 210 for programming and execution by the processor 204 to control the communications of the host 200 according to the protocols utilized in the subnet 108, 110, 116 to which the host 200 belongs. The memory 208 further comprises an ARP Request detection program 212 for programming the processor 204 to detect an ARP Request.

The memory 208 also includes a subnet determination program 214 for programming the processor 204 to determine whether the IP address contained in the ARP Request belongs to the local subnet of the host 200. In addition, the memory 208 includes an ARP response program 216 for programming the processor 204 to respond to an ARP Request with the MAC address of the Host 200 (alternatively, with a “dummy” MAC address), when the IP address contained in the ARP Request does not belong to the local subnet. The memory 208 further comprises a reverse tunnel program 218 for programming the processor 204 to reverse tunnel, through well-known techniques, a packet received from a MN 112 to the home subnet of the MN after the host 200 has returned a MAC address in response to an ARP Request from the MN. In addition, the memory 208 includes a subnet database 220 comprising information, such as IP addresses and subnet masks, pertaining to external subnets to and from which the host 200 is programmed to tunnel packets.

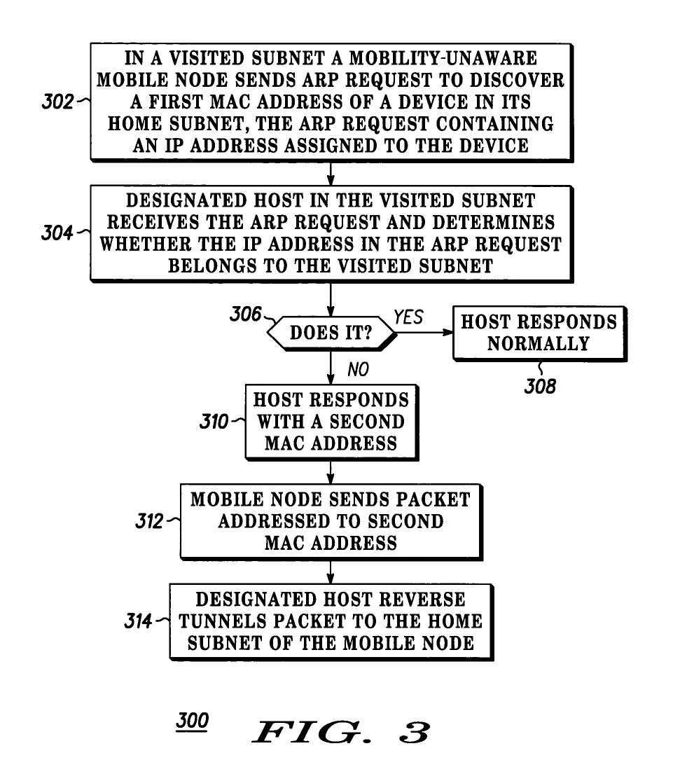

FIG. 3 is a flow diagram 300 depicting interactions between a host or designated host, such as host 200 and a MN, such as the MN 112. This flow chart will be explained in the context of or with reference to the structures and apparatus of FIG. 1 and FIG. 2 however it is understood that the underlying concepts and principles according to the method or process can be practiced by other entities or structures with appropriate or similar functionality. The flow begins in a visited subnet 110 different from the home subnet 108 when the mobility-unaware MN 112 has a packet to send and, in response, transmits 302 an ARP Request to discover the MAC address of a device, e.g., a host or a router (not shown), in its home subnet 108. The ARP Request contains the IP address assigned to the device in the home subnet. Next, a designated host, such as or comprising the wireless access point 106, in the visited subnet 110 receives 304 the ARP Request and determines whether the IP address in the ARP Request belongs to the visited subnet 110. If the IP address in the ARP Request belongs to the visited subnet 110, at 306, the designated host decides to respond normally 308. That is to say, if the IP address in the ARP Request is not that of the host, the host does not respond at all, and if the IP address in the ARP Request is that of the host, the host responds with its own MAC address.

On the other hand, if at 306 the designated host determines that the IP address in the ARP Request does not belong to the visited subnet 110, the host responds 310 with its own MAC address. Alternatively, the host can respond with a “dummy” MAC address not used elsewhere in the visited subnet 110. The MN 112 will assume that the MAC address has come from the device in its home subnet 108 and sends 312 the packet to the MAC address, either the MAC address of the host or the “dummy” MAC address. The designated host will receive the packet and will reverse tunnel 314 the packet to the home subnet 314, thereby advantageously assisting the MN 112 to send the packet to the desired destination.

Thus, it should be clear from the preceding disclosure that the present invention provides a method and apparatus for assisting a mobility-unaware MN to send a packet from a visited subnet. The method and apparatus advantageously allows the packet to be sent in a manner that is completely transparent to the MN.

This disclosure is intended to explain how to fashion and use various embodiments in accordance with the invention rather than to limit the true, intended, and fair scope and spirit thereof. The foregoing description is not intended to be exhaustive or to limit the invention to the precise form disclosed. Modifications or variations are possible in light of the above teachings. The embodiments were chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally, and equitably entitled.

1. A method for assisting a mobile node (MN) assigned to a home subnet and in a visited subnet to transmit a packet, the MN being unaware that the MN is no longer in the home subnet, the method comprising:
receiving from the MN an Address Resolution Protocol (ARP) Request to discover a first Medium Access Control (MAC) address of a device in the home subnet, the ARP Request containing an Internet Protocol (IP) address assigned to the device;
determining that said IP address does not belong to the visited subnet; and
returning, in response to determining that said IP address does not belong to the visited subnet, an ARP Response containing a second MAC address, to the MN.

2. The method of claim 1, further comprising:
receiving the packet addressed to the second MAC address; and
reverse tunneling the packet to the home subnet.

3. The method of claim 1,
wherein returning the second MAC address comprises returning a MAC address that is the MAC address of a designated host.

4. The method of claim 1,
wherein returning the second MAC address comprises returning a predetermined “dummy” MAC address that is not utilized elsewhere in the visited subset.

5. The method of claim 1,
wherein the visited subnet comprises a wireless network, and
wherein the receiving and the returning are performed a designated host comprising a wireless access point of the visited subnet.

6. The method of claim 1,
wherein the visited subnet comprises a wireline network, and
wherein the receiving and the returning are performed a designated host comprising a server in the visited subnet.

7. A host in a visited subnet configured to assist a mobile node (MN) that is assigned to a home subnet and in the visited subnet to transmit a packet, the MN being unaware that the MN is no longer in the home subnet, the host comprising:
a transceiver for communicating with the MN; and
a processor coupled to the transceiver for controlling the host, wherein the processor is programmed to cooperate with the transceiver to:
receive from the MN an Address Resolution Protocol (ARP) Request to discover a first Medium Access Control (MAC) address of a device in the home subnet, the ARP Request containing an Internet Protocol (IP) address assigned to the device;
determine that said IP address does not belong to the visited subnet; and
return in response to determining that said IP address does not belong to the visited subnet, an ARP Response containing a second MAC address, which the MN will assume to be the MAC address of said device in the home subnet.

8. The host of claim 7, wherein the processor is further programmed to:
return a MAC address that is the MAC address of the host.

9. The host of claim 7, wherein the processor is further programmed to:
return a predetermined “dummy” MAC address that is not utilized elsewhere in the visited subset.

10. The host of claim 7, further comprising
a network interface coupled to the processor for interfacing with a network,
wherein the processor is further programmed to cooperate with the transceiver and the network interface to:
receive, from the MN, the packet addressed to the second MAC address; and
reverse tunnel the packet to the home subnet.

11. The host of claim 10,
wherein the visited subnet comprises a wireless network, and
wherein the host comprises a wireless access point of the visited subnet.

12. The host of claim 10,
wherein the visited subnet comprises a wireline network, and
wherein the host comprises a server in the visited subnet.

13. A software program comprising executable instructions for assisting a mobile node (MN) assigned to a home subnet to transmit a packet, the MN being unaware that the MN is no longer in the home subnet, the software program, when executed in a host in a visited subnet, programming the host to:
receive from the MN an Address Resolution Protocol (ARP) Request to discover a first Medium Access Control (MAC) address of a device in the home subnet, the ARP Request containing an Internet Protocol (IP) address assigned to the device;
determine that said IP address does not belong to the visited subnet; and
return in response to determining that said IP address does not belong to the visited subnet, an ARP Response containing a second MAC address, which the MN will assume to be the MAC address of said device in the home subnet.

14. The software program of claim 13, further programming the host to:
receive, from the MN, the packet addressed to the second MAC address; and
reverse tunnel the packet to the home subnet.

15. The software program of claim 13, further programming the host to:
return a MAC address that is the MAC address of the host.

16. The software program of claim 13, further programming the host to:
return a predetermined “dummy” MAC address that is not utilized elsewhere in the visited subset.

17. The software program of claim 13,
wherein the visited subnet comprises a wireless network, and
wherein the software program is arranged to be executed in a wireless access point of the visited subnet.

18. The software program of claim 13,
wherein the visited subnet comprises a wireline network, and
wherein the software program is arranged to be executed in a server in the visited subnet.
